(19) United States
(12) Patent Application Publication
(10) Pub. No.: US 2022/0210520 A1
(43) Pub. Date: Jun. 30, 2022

(54) ONLINE VIDEO DATA OUTPUT METHOD, SYSTEM, AND CLOUD PLATFORM

(71) Applicant: GUANGZHOU HUYA TECHNOLOGY CO., LTD., Guangzhou (CN)

(72) Inventors: Jing YOU, Guangzhou (CN); Zhenmou QIU, Guangzhou (CN); Changhong YU, Guangzhou (CN)

(21) Appl. No.: 17/556,182

(22) Filed: Dec. 20, 2021

Related U.S. Application Data
(63) Continuation-in-part of application No. PCT/CN2020/097440, filed on Jun. 22, 2020.

(30) Foreign Application Priority Data
Jun. 21, 2019 (CN) 201910547506.7
Jun. 21, 2019 (CN) 201910547507.1
Jun. 21, 2019 (CN) 201910551828.9

(51) Int. Cl. H04N 21/647; H04N 21/658; H04N 21/654

(52) U.S. Cl. CPC H04N 21/64784; H04N 21/654; H04N 21/658

(57) ABSTRACT

Provided in the embodiments of the present application are an online video data output method, and a system, related to the technical field of the internet. The online video data output method is applicable in the cloud platform and comprises: receiving real-time information transmitted by a client and processing data on the basis of the real-time information to produce image information, the real-time information being transmitted from a server to the client for the client to forward to the cloud platform; acquiring rendering data from the image information and rendering on the basis of the rendering data to produce a rendered video; processing the rendered video to produce video data and outputting the video data.

### CROSS-REFERENCES TO RELATED APPLICATIONS

The present application claims the priorities of the Chinese patent application filed with the Chinese Patent Office on Jun. 21, 2019, with the present application number of 2019105518289, entitled as “Online Video Data Output Method, System and Cloud Platform”; the Chinese patent application filed with the Chinese Patent Office on Jun. 21, 2019, with the present application number of 2019105475071, entitled as “Information Processing Method, Cloud Platform and Information Processing System”; and the Chinese patent application filed with the Chinese Patent Office on Jun. 21, 2019, with the present application number of 2019105475067, entitled as “Method, System for Outputting Video Data Based on Cloud Platform and Cloud Platform”, the entire contents of which are incorporated to the present application by reference.

### TECHNICAL FIELD

The present application relates to the field of Internet technology, and specifically, provides an online video data output method, system, and cloud platform.

### BACKGROUND ART

Currently, there is a method of making software stored in a cloud server for operation. When using the above software, the user does not need to use his/her own hardware devices to perform the corresponding running, such that the user can use the powerful functions of the cloud server and avoid the increasing of the capital investment and maintenance costs for local devices. In practice, cloud servers that can bring about the above effects are generally collectively referred to as cloud platforms.

The aforementioned cloud platform can be applied in game scenarios. Correspondingly, the software stored in the cloud platform may be game software. With the example that the software which is running in the cloud platform is game software, when the game software is running, a large amount of underlying data, audio data, and video data will be generated in the cloud platform, such that the total data information is relatively sophisticated. When the user inputs the corresponding interactive instructions again, the total data information will become more sophisticated, which leads to the problem of high resource granularity (that is, a high degree of data mixing), and the difficulty of communication is increased to a certain extent.

### SUMMARY

Provided is an online video data output method, and the online video data output method is applicable to a cloud platform, the method including:

receiving real-time information transmitted by a client, and processing data according to the real-time information to obtain image information, and the real-time information is transmitted from a server to the client so that the client forwards to the cloud platform;

acquiring rendering data from the image information, and performing rendering according to the rendering data to obtain a rendered video; and

processing the rendered video to obtain video data, and outputting the video data.

Provided is a cloud platform, the cloud platform including:

a receiving unit, configured to receive real-time information transmitted by a client;

a processing unit, configured to process data according to the real-time information to obtain image information, and the real-time information is transmitted from a server to the client, so that the client forwards to the cloud platform;

an acquisition unit, configured to acquire rendering data from the image information;

a rendering unit, configured to perform rendering according to the rendering data to obtain a rendered video; and

an output unit, configured to process the rendered video to obtain video data, and output the video data.

Provided is an online video data output system, and the online video data output system includes a client and a cloud platform, the client is configured to receive real-time information and transmit the real-time information to the cloud platform, and the real-time information is transmitted from the server to the client;

the cloud platform is configured to receive the real-time information, and process data according to the real-time information to obtain image information;

the cloud platform is further configured to acquire rendering data from the image information, and perform rendering according to the rendering data to obtain a rendered video; and the cloud platform is further configured to process the rendered video to obtain video data, and output the video data.

Provided is a live broadcast device, including a memory and a processor, the memory is configured to store a computer program, and the processor runs the computer program to make the live broadcast device execute the online video data output method according to any one item of the first aspect of embodiments of the present application.

Provided is a computer readable storage medium, computer program instructions are stored in the computer readable storage medium, when the computer program instructions are read and run by a processor, the online video data output method according to any one item of the first aspect of embodiments of the present application is executed.

### BRIEF DESCRIPTION OF DRAWINGS

In order to explain the technical solutions of the embodiments of the present application more clearly, the drawings that need to be used in the embodiments of the present application will be briefly introduced as follows. It should be understood that the following drawings only show some embodiments of the present application. Therefore, they should not be regarded as a limitation on the scope. For those ordinarily skilled in the art, without creative work, other related drawings can be obtained based on these drawings.

FIG. 1 is a schematic flowchart of an online video data output method provided by various embodiments of the present application;

FIG. 2 is a schematic flowchart of another online video data output method provided by various embodiments of the present application;

FIG. 3 is a schematic structural diagram of a cloud platform provided by various embodiments of the present application;

FIG. 4 is a system schematic diagram of an online video data output system provided by various embodiments of the present application; and

FIG. 5 is a system schematic diagram of another online video data output system provided by various embodiments of the present application.

### DETAILED DESCRIPTION OF EMBODIMENTS

The technical solutions of the present application will be described in detail below with reference to the accompanying drawings and specific embodiments. It should be understood that the embodiments of the present application and the specific features in the embodiments are detailed descriptions of the technical solutions of the present application, rather than limitations of the technical solutions of the present application. In the case of no conflict, the embodiments of the present application and the technical features in the embodiments may be combined with each other.

The present application provides an online video data output method and system, which can reduce the resource granularity generated in the cloud platform, avoid certain communication obstacles, and can be applied online.

The embodiments of the present application provide an online video data output method, and the online video data output method is applicable to a cloud platform, the method including:

receiving real-time information transmitted by a client, and processing data according to the real-time information to obtain image information, and the real-time information is transmitted from a server to the client so that the client forwards to the cloud platform;

acquiring rendering data from the image information, and performing rendering according to the rendering data to obtain a rendered video; and

processing the rendered video to obtain video data, and outputting the video data.

In the foregoing implementation process, first, the real-time information transmitted by the client can be received by the cloud platform in real time, and the real-time information can be transmitted by the server to the client and then forwarded by the client to the cloud platform. Herein, the above real-time information is real-time data in the server, and the real-time data may include underlying information, audio and video information, and so on. After the cloud platform receives the real-time information, it performs corresponding data processing on the real-time information to obtain the image information related to the display, in the real-time information. Herein, the image information is real-time image information, and the image information includes rendering data used to render the video. Rendering data is acquired from the image information and the rendering is performed based on the rendering data to obtain a rendered video after rendering; and the rendered video is processed (which may include encoding processing) to obtain video data for transmission.

With implementing this embodiment, online interaction tasks can be completed in real time, and video data can be transmitted in real time, thereby ensuring the progress of the online tasks. In addition, by implementing this embodiment, it is also possible to complete the acquisition of image information and even rendering data by extracting and classifying the real-time information, and then complete the generation of the rendered videos through the combination of resource scheduling and rendering data in the cloud platform, thereby forming a rendered video generation process, in which a task is fulfilled dedicatedly, thereby reducing the resource granularity in the cloud platform, that is, reducing the mixing degree of resource data in the cloud platform, which avoids the problems, such as system crashes and downtime caused by high mixing degree of data.

The second aspect of the embodiments of the present application provides a cloud platform, the cloud platform including:

a receiving unit, configured to receive real-time information transmitted by a client;

a processing unit, configured to process data according to the real-time information to obtain image information, and the real-time information is transmitted from a server to the client, so that the client forwards to the cloud platform;

an acquisition unit, configured to acquire rendering data from the image information;

a rendering unit, configured to perform rendering according to the rendering data to obtain a rendered video; and

an output unit, configured to process the rendered video to obtain video data, and output the video data.

In the above implementation process, the cloud platform includes five units: a receiving unit, a processing unit, an acquisition unit, a rendering unit, and an output unit. These five units respectively perform their duties and complete their corresponding work content, so that the above five units can form a complete entirety organically. Optionally, through five independently operating units, each of the work contents can be well controlled, thereby ensuring a low degree of crossover of works and ensuring the smooth progress of operation of the cloud platform. That is, it enhances the stability of operation of the cloud platform and reduces the resource granularity generated by the cloud platform. In the above implementation process, the cloud platform communicates with the client, and the client communicates with the server. Therefore, it can be known from the above-mentioned receiving unit and output unit that the cloud platform is applied to a system having a server, a client, and a cloud platform, and thus the cloud platform can be applied in online scenarios.

The third aspect of the embodiments of the present application provides an online video data output system, and the online video data output system includes a client and a cloud platform, the client is configured to receive real-time information and transmit the real-time information to the cloud platform, and the real-time information is transmitted from the server to the client;

the cloud platform is configured to receive the real-time information, and process data according to the real-time information to obtain image information;

the cloud platform is further configured to acquire rendering data from the image information, and perform rendering according to the rendering data to obtain a rendered video; and the cloud platform is further configured to process the rendered video to obtain video data, and output the video data.

In the foregoing implementation process, the online video data output system includes a client and a cloud platform. Optionally, the system may also include a server. Herein, the client receives the real-time information transmitted by the server, and forwards the real-time information to the cloud platform. The cloud platform, when receiving the above real-time information, performs data processing according to the real-time information to obtain image information, and acquires the rendering data from the image information, and then performs the rendering according to the rendering data to obtain the rendered video, and further processes the rendered video (which may be the encoding process) to obtain video data and outputs the video data.

With implementing this embodiment, the output of online video data can be completed through the interaction between the client and the cloud platform and the operation of the cloud platform. The processing on real-time information by the cloud platform involves image information and rendering data, and the operation of the cloud platform has pertinence (that is, as for images and rendering). Therefore, compared with the traditional cloud platform, the resource granularity generated in this cloud platform is lower, and no obstacles that affect communication, such as system crashes and downtimes, caused by high degree of data mixing or similar reasons, will be generated, thereby improving the stability of the system. Moreover, the system is also a system applied online. Compared with the traditional cloud platform, it can complete online interaction tasks in real time.

The fourth aspect of the embodiments of the present application provides a live broadcast device, including a memory and a processor, the memory is configured to store a computer program, and the processor runs the computer program to make the live broadcast device execute the online video data output method according to any one item of the first aspect of embodiments of the present application.

The fifth aspect of the embodiments of the present application provides a computer readable storage medium, computer program instructions are stored in the computer readable storage medium, when the computer program instructions are read and run by a processor, the online video data output method according to any one item of the first aspect of embodiments of the present application is executed

The technical solutions in the embodiments of the present application will be described below in conjunction with the drawings in the embodiments of the present application.

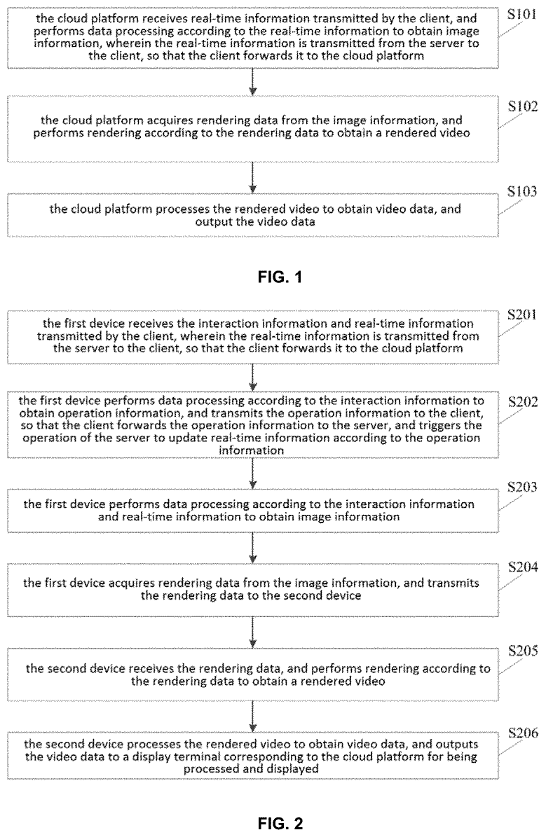

Referring to FIG. 1, FIG. 1 is a schematic flowchart of an online video data output method provided by an embodiment of the present application. In various embodiments, the online video data output method is applied online. Optionally, the method can be applied to live broadcast scenes, video meeting scenes, or other scenes of multiple types that require image display or screen projection. Herein, the online video data output method is applied to the cloud platform, and specifically includes:

S101, the cloud platform receives real-time information transmitted by the client, and performs data processing according to the real-time information to obtain image information, and the real-time information is transmitted from the server to the client, so that the client forwards it to the cloud platform.

Optionally, the client can be software. When the client is software, the client has input and output functions and the client can also have certain data output functions. For the video display function, in this application, no restriction is made.

Optionally, when the client is software, the client can select any device that meets certain conditions as its carrier, and its conditions can include data transmission condition. On the basis of the foregoing description, the carrier may be any one of a data box, a switch (interchanger), and a data transmission terminal, and in this application the type of the carrier is not limited in any way.

Optionally, when the client is software, it may also have data input conditions or output conditions. On the basis of the above description, the carrier thereof may be a terminal device with a communication function, such as a handle and a button terminal, which is not limited in this application.

Optionally, when the client is software, it may also have display conditions. On the basis of the foregoing description, its carrier may be an electronic device, such as a mobile phone, a platform, or a computer, which is not limited in this application.

Optionally, the client may be hardware, for example, the client may be a handle, a mobile phone, a projector, and so on. When the client has the above-mentioned capabilities, the type or kind of the client is not limited in this application.

Optionally, real-time information is real-time operating (running) information generated and stored on the server. Optionally, the real-time information can be meeting information or game information. In this application, the content of real-time information is not limited. It only limits the fact that the information is real-time. Because of this reason, the real-time information is the basic condition for running the method online.

Optionally, the real-time information is transmitted from the server, which means that in this method, the information from the server is required for the following-up, that is, the method can be applied online.

Optionally, no connection exists between the server and the cloud platform. It is possible that the cloud platform does not have the permission to connect with the server, that is, the server does not want to connect with the cloud platform, so the server does not give the corresponding communication authorization to the cloud platform. For example, the client has the authorization of the server and software, but the client does not perform the rendering operation or even the interaction operation, which allows the cloud platform to perform tasks that the client does not perform. For example, the client can retrieve data from the server when being operated, and transmit it to the cloud platform for processing, thus forming a chained data transmission from the server, to the client, to the cloud platform, so that the server is not needed to interact with the cloud platform. It can be seen that this method is based on online operations, but also based on the client.

Optionally, the step of the cloud platform performing the data processing based on real-time information to obtain image information may include:

segmenting information according to real-time information to obtain image information, audio information, and data information; and

acquiring the above-mentioned image information.

With implementing this embodiment, the cloud platform can process the information of the corresponding category, thereby avoiding cross-processing of data.

Optionally, the information division can be performed according to GUI (Graphical User Interface). Optionally, the operation logic, the audio data, and the video data (i.e., image information) can be obtained by division according to the GUI.

Optionally, the real-time information does not include the input information in the GUI, and the input information is the interaction information described later.

S102, the cloud platform acquires rendering data from the image information, and performs rendering according to the rendering data to obtain a rendered video.

Optionally, the image information may include multiple types of image-related information, such as texture information (mapping information), coordinate information, RGB information, and rendering data, which is not limited in this application.

Optionally, the rendering data may include various image information used for rendering and the rendering rules and methods. The content specifically included in the rendering data is not specifically limited in this application.

Optionally, when the cloud platform has image resources, the cloud platform only needs to acquire the rendering rules in the rendering data to complete the rendering. As another possible embodiment, when image resources in the cloud platform are insufficient, the rendering data may include image resources. In addition, in other possible embodiments, when there are higher-order rendering rules in the cloud platform, it is possible to only transmit the most basic image information.

S103, the cloud platform processes the rendered video to obtain video data, and output the video data.

As an optional embodiment, the step of processing the rendered video to obtain video data may include:

performing a encoding processing on the rendered video to obtain video data. This embodiment is performed to facilitate the transmission.

Optionally, a unique identification code or other authentication means can be set in the foregoing processing process, which is not limited in this application.

Optionally, the method of outputting video data is not limited.

Optionally, the client can be a mobile phone, the server can be a game server, and the cloud platform can be a game cloud platform. Herein, when a user uses a mobile phone to play a game, the game running on the mobile phone is connected to the game server. At this time, the game server transmits real-time information to the mobile phone. The mobile phone receives the real-time information but does not process the real-time information, and contrarily, it forwards the real-time information to the game cloud platform, enabling the game cloud platform to perform the processing according to the received real-time information, to obtain the rendered video, and output the encoded rendered video stream to the corresponding device, so that the corresponding device can be watched. Herein, the mobile phone can display or not display the rendered video, and the rendered video displayed by the mobile phone can be sent back by the game cloud platform (it can be self-rendered display). The rendered video (online game video) can be displayed and played online for more people to watch.

Optionally, the cloud platform can perform the basic processing and the transmission display of the game. When the cloud platform transmits video data to the client, the client will complete the cloud game process on the basis of no games. Herein, the server is still connected to the client. When the user does not want to play cloud games, the connection between the client and the server can be cut off, without using the cloud platform, so that the real-time character of the operation can be increased.

Optionally, in practice, the operation, display, etc. do not have a delay or the delay is maintained within an allowable range, so that it does not have any influence on the user's use.

Optionally, the execution subject can be a cloud platform, or a cloud server with special capabilities, or even a data transmission terminal based on certain technologies (terminals with corresponding data processing capabilities), which is not limited in this application.

Optionally, the online video data output method described in FIG. 1 is implemented. The cloud platform can complete the online interaction tasks in real time and transmit the real-time video data, thereby ensuring the progress of online tasks. In addition, with implementing this embodiment, the cloud platform can also complete the acquisition of image information and even rendering data by extracting and classifying real-time information, and then complete the generation of rendered video through the combination of resource scheduling and rendering data in the cloud platform, so as to form a rendered video generation process, in which a task is fulfilled dedicatedly, thereby reducing the resource granularity in the cloud platform, that is, reducing the mixing degree of resource data in the cloud platform, which avoids the problems, such as system crashes and downtimes caused by high degree of data mixing, and improves the stability of the system.

Referring to FIG. 2, FIG. 2 is a schematic flowchart of another online video data output method provided by an embodiment of the present application. The schematic flowchart of the online video data output method described in FIG. 2 is obtained by improving the schematic flowchart of the online video data output method described in FIG. 1. In various embodiments, the online video data output method is applied to a cloud platform, and the cloud platform is composed of a first device and a second device. Optionally, the first device is an operating server, and the second device is a rendering server. In another possible embodiment, the first device is an operating platform, and the second device is a rendering platform. Herein, the operating platform may be any one of multiple operating platforms included in the operating server, and the rendering platform may be any one of multiple rendering platforms included in the rendering server. The online video data output method includes the following steps.

S201, the first device receives the interaction information and real-time information transmitted by the client, and the real-time information is transmitted from the server to the client, so that the client forwards it to the cloud platform.

Optionally, the cloud platform may receive interaction information and real-time information transmitted by the client, and optionally, it may be executed by the first device in the cloud platform. As a possible embodiment, the client can be software. When the client is software, the client has input and output functions and the client can also have certain data output functions. The video display function is not limited in this application.

Optionally, when the client is software, the client can select any device that meets certain conditions as its carrier, and the conditions can include data transmission conditions. The client may also have data input conditions or output conditions, and the client may also have display conditions.

Optionally, the first device and the second device are two servers of the cloud platform or sub-platforms in the server. Optionally, it is possible that the first device and the second device are not located on the same carrier. For example, the first device and other first devices may share one carrier, and the second device and other second devices may share one carrier, so as to achieve the effect that one task is fulfilled dedicatedly, thereby reducing the resource granularity generated by the cloud platform, that is, reducing the data interference caused by crossover of information.

Optionally, the first device is used for interaction and running programs, and the second device is used for rendering, which will not be repeated in this embodiment.

Optionally, the interaction information is information input by the user through the client, that is, interaction information in which online users participate. As an embodiment, the interaction information may be operation information performed by the user when playing a cloud game. As another embodiment, the interaction information may also be the operation information of turning page when the user uses the projecting on a public screen or makes speaking with PPT.

Optionally, the content described in the foregoing may be referred to for the real-time information, which will not be described in this embodiment. Optionally, the interaction information may be the input information in the aforementioned GUI division.

S202, the first device performs data processing according to the interaction information to obtain operation information, and transmits the operation information to the client, so that the client forwards the operation information to the server, and triggers the operation of the server to update real-time information according to the operation information.

Optionally, the interaction information may be an operation instruction input by the user at the client, that is, the interaction information is the information for interaction, and does not have any influence on the software. Therefore, the operating information obtained by processing the interaction information in the software is the information that affects the software itself.

The first device may obtain operation information which is generated by the software according to the interaction information, and the operation information is used to be fed back to the server, so that the content in the server is changed (updated) according to the interaction information input by the user. The content described above is the basic operation content for the online interaction. In the above implementation process, the cloud platform, after processing the interaction information received from the client to obtain the operation information, then forwards the operation information to the server through the client, such that the server performs the data replacement and the picture replacement according to the results of the underlying operations of the software in the cloud platform, thereby completing the replacement of real-time information, and thereby ensuring the uninterrupted and stable online interaction. On the other hand, the implementation of the foregoing implementation process can continuously implement online interaction behavior when the cloud platform is not in communication with the server, thereby ensuring the stability and universality of the online interaction.

Optionally, the operation information that affects the software itself can be sent back to the server, so that the operation information, via the client, backs to the server to update the real-time information. For example, the operation of the user affects the factors of the software world, and the operation information will adjust the affected factors according to the rules of the software world, so that new real-time information appears correspondingly in the software world, and then other subsequent operations are promoted.

Optionally, the updated real-time information is the real-time information being in the process, and the updated information can be applied to the same process in the next frame. It can be seen that the method is a method that runs in real time when operating online.

For example, when a player is playing a game, the information that the user sees every time is a picture corresponding to the real-time information. When the refresh frequency is high enough, multiple pictures viewed by the user are connected to form a video, so as to avoid the player from watching uncomfortably during playing the game. In this technical solution, this method can also use means, such as softening and sharpening, to ensure the normal running of the real-time pictures, and even, in the case of a bad network, the quality of the outputted and displayed pictures is automatically adjusted to ensure playing experience of the player.

S203, the first device performs data processing according to the interaction information and real-time information to obtain image information.

The above-mentioned interaction information may be an operation instruction input by the user, which generally affects the transformation of the images. Therefore, the image information may be obtained after the data processing is performed based on the interaction information and real-time information. With implementing this embodiment, the acquisition of image information becomes closely related to the interaction information transmitted by the client. It can be seen that in an online system, image information is comprehensively determined by using both interaction information and real-time information. Therefore, in this step, user factors can be added on the basis of obtaining image information, so that the above image information can be combined with user behavior, and then the image information based on user operations and even corresponding rendered videos can be obtained, realizing the function of making the online users interacted with the cloud platform.

Optionally, as a possible embodiment, when the cloud platform is used to run game software, the first device may perform the data segmentation processing according to the received real-time information transmitted by the client, to obtain the scene information and the game architecture data information corresponding to the game software. The first device adjusts the scene information according to the acquired interaction information of the client and the game architecture data information to obtain the image information.

In the above implementation process, when the cloud platform runs the game software, the cloud platform can obtain the interaction information input by the user and the real-time information transmitted by the server, and perform the data segmentation on the real-time information to obtain the scene information and the game architecture data information (the game underlying data information, an information group used for designating the basic rules of the game content) corresponding to the game software. The content in the interaction information is converted into operation control information according to the game architecture data information, and the scene information is adjusted according to the operation control information, thereby obtaining the image information for controlling image display. It can be seen that the implementation of this embodiment can ensure that no data disorder or data collapse occurs in the process of acquiring the image information, thereby improving the stability of the image information acquisition.

S204, the first device acquires rendering data from the image information, and transmits the rendering data to the second device.

Optionally, the image information may include various kinds of information related to the image, such as texture information, coordinate information, RGB information, and rendering data, which is not limited in this application.

Optionally, the rendering data may include various kinds of image information used for the rendering and the rendering rules and methods. The content specifically included in the rendering data is not specifically limited in this application.

Optionally, the rendering data is used for rendering, so that the content included in the rendering data can meet the rendering conditions, which is not limited in this application.

Optionally, the method for rendering to obtain rendered video according to the rendering data is not limited. Optionally, the rendering method may include the methods, such as the framing rendering (single-frame or multi-frame rendering method), the full-frequency rendering (integrated rendering method) and the like.

Optionally, as a possible embodiment, the first device receives the interaction information and real-time information transmitted by the client, and performs data processing according to the interaction information and the real-time information, when image information is obtained, the obtained image information includes control information.

When the first device acquires the rendering data from the image information and transmits the rendering data to the second device, it is possible that the first device decouples the control information in the image information, obtains the rendering data, and transmits the rendering data to the second device.

In the foregoing implementation process, the first device may acquire the interaction information of the client, and process data according to the interaction information to obtain control information. Interaction information refers to information which is input by the user through the client, and the control information refers to information that acts on an application program running on the first device, which usually couples multiple types of information. Herein, the control information couples rendering data and other data, and the other data may be business logic data of the corresponding application program and the like. The rendering data may include various kinds of image information used for the picture rendering and the rendering rules and methods. The first device decouples the various kinds of information contained in the control information to obtain the rendering data that is, extracting the rendering data from the control information. The rendering data is transmitted to the second device, and the second device implements the rendering processing. In this embodiment, it can avoid excessive loss of virtual machines. The first device can run multiple application programs, and the second device can perform the video rendering on pictures of multiple application programs, which facilitates the data management and control management of the cloud platform, and greatly improves the resource utilization rate of the cloud platform, so that the cloud platform can have better applications and facilitate the realization of larger-scale operations.

Optionally, the step of the above-mentioned first device decoupling the control information in the image information to obtain rendering data and transmitting the rendering data to the second device includes:

the first device decoupling the control information in the image information to obtain business logic data and rendering data; and

the first device extracting the rendering data and transmitting the rendering data to the second device.

On this basis, the first device can process the business logic data to advance the business logic progress of the first device.

In the foregoing implementation process, the first device performs decoupling processing on the control information in the image information to obtain business logic data and rendering data. The business logic data is the information acting on the application program running on the first device. The business logic data is processed by the first device to advance the business logic progress of the first device. The first device uses the business logic data to advance the business logic progress of the application program instead of using the control information to advance, which can improve the advancing efficiency of the business logic progress, so that the first device can have a better operating effect, which more facilitates data management and control management of the cloud platform.

S205, the second device receives the rendering data, and performs rendering according to the rendering data to obtain a rendered video.

Optionally, as a possible embodiment, the second device may receive the rendering data, obtain the network material corresponding to the rendering data, and perform the rendering on the rendering data and the network material to obtain the rendered video.

In the foregoing implementation process, the second device may perform rendering according to both the network material and the rendering data, so as to obtain the rendered video. Implementation of this embodiment can improve the display accuracy of the rendered video, and can save the occupied memory space in the cloud platform.

S206, the second device processes the rendered video to obtain video data, and outputs the video data to a display terminal corresponding to the cloud platform for being processed and displayed.

In the foregoing implementation process, the second device may perform the encoding processing or the processing in other forms on the rendered video to obtain video data for transmission, and output the video data to the display terminal corresponding to the cloud platform. Optionally, the display terminal may be connected to the second device correspondingly, so that the display terminal can receive the video data and perform the decoding operation or other operations on the video data to obtain the rendered video, and then the display terminal can display the rendered video. It can be seen that by implementing this embodiment, the rendered video can be displayed on the display terminal connected to the cloud platform, thereby realizing the operation of outputting the video.

Optionally, the display terminal and the client may be two different software, and their carriers may be the same or different. Optionally, the display terminal is used to display the rendered video.

Optionally, the processing of the second device may be encoding processing, and the processing of the display terminal may be the decoding processing, and the two processing operations are corresponding to each other, and specifically, processing such as encryption and identification may also be included.

Optionally, the above-mentioned multiple steps can be deployed in different operating carriers for execution. For example, Step S201 is deployed in a near-user server in the first device to receive the real-time information faster. As another example, Steps S202 to S203 are deployed in an idle server to obtain higher processing efficiency. As another example, Step S205 is deployed in a multi-thread high-capacity server to obtain a better rendering effect. It can be seen that using this method can effectively make each step run more perfectly, thereby obtaining a better use effect of the cloud platform.

Optionally, the client is a mobile phone, the server is a game server, the display terminal is a viewer device, the first device is an interaction server, and the second device is a rendering server. In the practice process, the mobile phone acquires the data of the game server and receives the operation of the user for online play. Herein, the processing of the underlying data is performed in the first device, and the second device is used for picture acquisition, rendering and outputting, so that the playing of the user can be watched on the viewer device. Optionally, the mobile phone can perform the real-time display based on the data of the game service, thereby forming a dual-end display of the mobile phone and the viewer device, avoiding the traditional screen recording operation. With the dual-platform working mode of the first device and the second device, the video data can be obtained more effectively and the video data is outputted so that it can be watched on the viewer device.

In the foregoing implementation process, the cloud platform is segmented into a first device and a second device, and operations, such as obtaining real-time information, data processing, data extraction, rendering video, and outputting data, can be deployed into the corresponding operating platforms, respectively. Herein, the first device may be configured to obtain real-time information and perform the data processing on the real-time information to obtain image information, and then perform the data extraction on the image information to obtain the rendering data, and transmit the rendering data to the second device. When the second device receives the above-mentioned rendering data, the second device performs corresponding image rendering according to the rendering data to obtain the corresponding rendered video, and then performs corresponding operations, such as encoding processing, on the rendered video to obtain the video data and outputs the video data. It can be seen that by implementing this embodiment, multiple operations, of acquiring real-time information, performing data processing on real-time information, and processing rendering data, can be performed by the first device. The second device can also perform multiple operations of rendering video and outputting video data, so as to ensure that the first device and the second device perform their own duties. Further, the work contents of the first device and the second device are very clear and do not overlap with each other. Therefore, in the process of using the cloud platform, there will be no situation of high degree of data mixing, thus ensuring that the resource granularity in the cloud platform will not be too high, thereby improving the operation ability of the cloud platform and the ability to be coordinated and supervised (because the first device and the second device are two platforms and during the management process, it is enough to simultaneously manage multiple first devices or multiple second devices).

In the above implementation process, the cloud platform is segmented into two parts: the first device and the second device. Optionally, the first device and the second device are organically combined to form the cloud platform, and the carriers of the first device and the second device can be different. For example, when there are a running server with multiple running platforms and a rendering server with multiple rendering platforms, the running server and the rendering server can constitute a complete cloud platform. Or, one running platform and one rendering platform are extracted from two servers to constitute a complete cloud platform. Herein, the organic combination is realized by the communication between the first device and the second device. After splitting the cloud platform, the first device and the second device each complete all the tasks of the original cloud platform. Herein, the first device starts to receive real-time information, processes real-time information, and completes the acquisition and transmission of image data, while the second device performs rendering, processing (such as, encoding, encryption, and other types of processing) and outputting of the image data. It can be seen that splitting the cloud platform can effectively separate the interaction function, running function and rendering function, so as to achieve the effect that each of them performs the high-precision work, thereby reducing the resource granularity generated during the operation of the cloud platform. With reference to the above content, it can be known that when there is only one type of platform in a server, the consumption of management, operation and maintenance thereof will be greatly reduced. Therefore, this method can also improve capabilities of the management, operation and maintenance of the cloud platform, thus better achieving the work of the cloud platform.

Optionally, as a possible embodiment, the aforementioned control information is obtained by the first device performing the data processing on the acquired interaction information of the first client.

After the above-mentioned step that the second device processes the rendered video to obtain video data and outputs the video data, the second device can transmit the video data to the first client, so that the first client displays the video corresponding to the video data. Alternatively, the second device may transmit video data to the first client and the second client, so that the first client and the second client display videos corresponding to the video data.

In the foregoing implementation process, the interaction information of the client includes the interaction information of the first client. After the second device receives the rendering data and processes according to the rendering data to obtain the rendered video data, the second device transmits the video data to the first client, so that the first client displays the video corresponding to the video data. This situation is the situation in which the application program is deployed to run on the first device of the cloud platform, and the user transmits the input interaction information to the first device of the cloud platform through the first client, and advances the first device to run the business logic progress of the application program, and the first client is used to receive the video data of the pictures corresponding to the application program, and display the video. As a possible embodiment, this situation can be cloud game or cloud office, etc.

Optionally, after the second device receives the rendering data and processes according to the rendering data to obtain the rendered video data, the second device transmits the video data to the first client and the second client, so that the first client and the second client display the video corresponding to the video data. In this situation, a second client is added, which is also capable of receiving the video data of the pictures corresponding the application program and displaying the video, on the basis of the above situation. In this case, the process of the user operating the application program is broadcast live. In this embodiment, the second device is used to transmit out video data, which can improve the operating capability and operating efficiency of the first device, thereby better achieving the data management and the control management of the cloud platform.

Optionally, the aforementioned interaction information may include the game operation information, and the control information may be obtained by the first device performing the data processing on the acquired game operation information of the client.

The video data includes game video data, and the second device may receive the rendering data and perform rendering according to the rendering data to obtain the rendered video, process the rendered video to obtain the rendered game video data, and output the game video data.

In the foregoing implementation process, the interaction information includes game operation information, and the video data includes game video data, that is, the application program of corresponding client is a game. In this embodiment, the cloud platform can better realize data management and control management, and the resource utilization rate is high, and it can realize the operation of cloud games with more people and larger scale.

Optionally, as a possible embodiment, the interaction information may include the working software information, and the control information is obtained by the first device performing data processing on the acquired working software information of the client. The second device may receive the rendering data, perform rendering according to the rendering data to obtain the rendered video, process the rendered video to obtain the rendered working video data, and output the working video data.

In the foregoing implementation process, the interaction information includes working software operation information, and the video data includes working video data, that is, the application program of corresponding client is the working software. In this embodiment, the cloud platform can better realize data management and control management, and the resource utilization rate is high, and it can realize the operation of cloud office with more people and larger scale.

Optionally, as a possible embodiment, the interaction information includes remote meeting communication information, and the control information is obtained by the first device performing data processing on the acquired remote meeting communication information of the client.

The video data includes remote meeting video data. The second device may receive the rendering data, and perform rendering according to the rendering data to obtain the rendered video, process the rendered video to obtain the rendered remote meeting video data, and output the remote meeting video data.

In the foregoing implementation process, the interaction information includes remote meeting communication information, and the video data includes remote meeting video data, that is, the application program of corresponding client is a remote meeting. In this embodiment, the cloud platform can better realize data management and control management, and the resource utilization rate is high, and it can realize the operation of cloud meeting with more people and larger scale.

The online video data output method provided by this embodiment can complete the online interaction tasks in real time and transmit real-time video data, thereby ensuring the progress of online tasks. With implementing this embodiment, it is also possible to extract and classify real-time information to complete the acquisition of image information and even rendering data, and then complete the generation of rendered videos through the combination of the resource scheduling in the cloud platform and rendering data. Thus, a rendered video generation process in which a task is performed dedicatedly is formed, which reduces the resource granularity in the cloud platform. The method can also integrate the interaction between the client and the server and the interaction between the client and the cloud platform to form a whole, to form a complete interaction system, so as to complete in parallel an online data interaction and the generation and output of video data, and then obtain the implementation of video data based on user operations and underlying data, ensuring that it has the abilities, such as taking into account the external display while operating online.

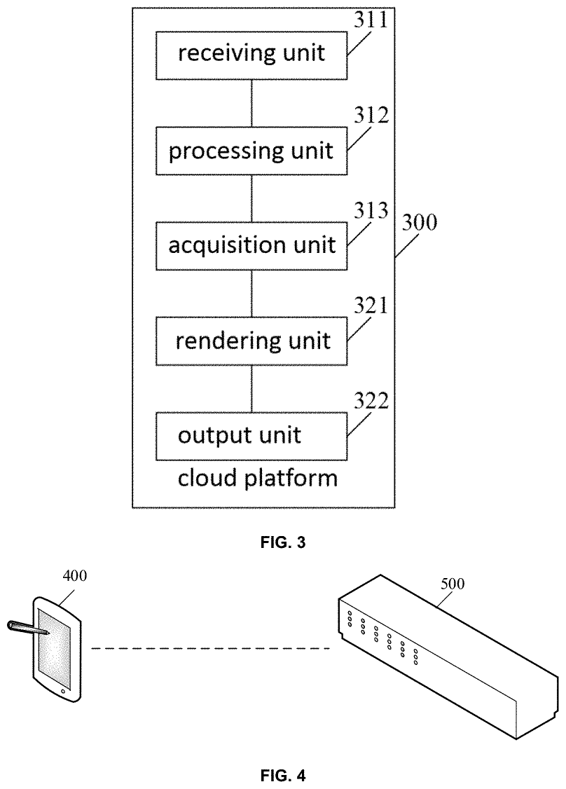

Referring to FIG. 3, FIG. 3 is a schematic structural diagram of a cloud platform 500 provided by an embodiment of the present application. In various embodiments, the cloud platform 500 includes:

a receiving unit 311, configured to receive real-time information transmitted by a client 400;

a processing unit 312, configured to process data according to the real-time information, to obtain image information, and the real-time information is transmitted from a server 300 to the client 400, so that the client forwards it to a cloud platform 500;

an acquisition unit 313, configured to acquire rendering data from the image information;

a rendering unit 321, configured to perform rendering according to the rendering data to obtain a rendered video; and

an output unit 322, configured to process the rendered video to obtain video data, and output the video data.

Optionally, the receiving unit 311, the processing unit 312, and the acquisition unit 313 may be carried on the first device 510 included in the cloud platform 500, and the rendering unit 321 and the output unit 322 may be carried on the second device 520 included on the cloud platform 500.

Optionally, the client can be software. When the client is software, the client has input and output functions and the client can also have certain data output functions. The video display function is not limited in this application.

Optionally, when the client is software, the client can select any device that meets the certain conditions as its carrier, and the condition may include data transmission condition. On the basis of the foregoing description, the carrier may be any one of a data box, a switch, and a data transmission terminal, and the type of the carrier is not limited in any way in this application.

Optionally, when the client is software, it may also have data input conditions or output conditions. On the basis of the above description, its carrier may be a terminal device with a communication function, such as a handle and a button terminal, which is not limited in this application.

Optionally, when the client is software, it may also have display conditions. On the basis of the foregoing description, the carrier thereof may be an electronic device, such as a mobile phone, a platform, or a computer, which is not limited in this application.

Optionally, the client can be hardware. Optionally, the client can be a handle, mobile phone, projector, etc. When the client has the above capabilities, the type or kind of the client is not limited in this application.

Optionally, multiple units included in the cloud platform 500 can be deployed separately. For example, the receiving unit 311 that receives real-time information is arranged near the user, so that the receiving unit 311 can receive real-time information more quickly. As another example, the processing unit 312, the acquisition unit 313, and the rendering unit 321 are separately deployed, such that each unit works differently completely, therefore, the result obtained by each task is accurate and reliable. In addition, the output unit 322 can still be arranged near the user, so that the user can receive video data faster. It can be seen that this method can reduce the external data transmission process of the cloud platform 500, thereby effectively reducing the use delay and improving the use effect of the cloud platform 500.

Optionally, the real-time information is real-time operating information generated and stored in the server. Optionally, the real-time information can be meeting information or game information. The content of real-time information is not limited in this application, and it is only limited that the information has the real-time character, because of which the real-time information is the basic condition for running the method online.

Optionally, the real-time information is transmitted by the server, which means that in the method, it is possible to use the information of the server for the following-up, that is, in the method, it can be applied online. When the server does not exist or the real-time information does not exist, this method will be difficult to further follow up to be performed.

Optionally, the server is not connected with the cloud platform, that is, the cloud platform does not have the permission to connect with the server, that is, the server does not want to connect with the cloud platform, and therefore, the server does not give the corresponding communication authorization to the cloud platform. For example, the client has the authorization of the server and the software, and however the client does not perform the rendering operation or even the interaction operation, which allows the cloud platform to perform tasks that the client does not perform. For example, the client can retrieve data from the server when it is operated and transmit it to the cloud platform for processing, thus forming a chained data transmission from the server to the client to the cloud platform, therefore it is possible that the server does not make the interaction with the cloud platform. It can be seen that this method is based on online operation, and also is based on the client.

Any of the explanations and descriptions described in the foregoing can be applied to the cloud platform 500, which will not be repeated in this application.

Optionally, the cloud platform 500 shown in FIG. 3 includes five units: a receiving unit 311, a processing unit 312, an acquisition unit 313, a rendering unit 321, and an output unit 322. These five units each perform their own duties and complete their corresponding work content, so that the above five units can form a complete entirety organically. Through the five units which are independently operating, the work content of each of them can be well controlled, thereby ensuring that the crossover degree of work is low, and ensuring the smooth progress of the work of the cloud platform 500, that is, enhancing the work stability of the cloud platform 500 and reducing the resource granularity generated by the cloud platform 500. In the foregoing implementation process, the cloud platform 500 communicates with the client, and the client communicates with the server. Therefore, in combination with the foregoing receiving unit and output unit, it can be seen that the cloud platform 500 is applied to the system having a server, a client, and the cloud platform 500. Therefore, the cloud platform 500 is applied in an online scenario. The cloud platform 500, in practice, can improve the use effect of the cloud platform 500 by deploying units in different positions.

Referring to FIG. 4, FIG. 4 is a schematic system structural diagram of an online video data output system provided by an embodiment of the present application. In various embodiments, the online video data output system includes a client 400 and a cloud platform 500.

The client 400 is configured to receive real-time information and transmit the real-time information to the cloud platform 500, and the real-time information is transmitted from the server 300 to the client 400.

The cloud platform 500 is configured to receive real-time information, and process data according to the real-time information to obtain image information.

The cloud platform 500 is also configured to acquire rendering data from the image information, and perform rendering according to the rendering data to obtain a rendered video.

The cloud platform 500 is also configured to process the rendered video to obtain video data, and output the video data.

Optionally, the cloud platform 500 included in the online video data output system may be the cloud platform 500 described in the foregoing, which will not be repeated in this application.

Optionally, any of the explanations and descriptions described in the foregoing can be applied to the online video data output system, which will not be repeated in this application.

By implementing the online video data output system shown in FIG. 4, the output of online video data can be completed through the interaction between the client and the cloud platform 500 and the work of the cloud platform 500. The processing, which is made on real-time information by the cloud platform 500, may include processing on image information and processing on rendering data. The work of the cloud platform 500 has its target (that is, for the image and the rendering). Therefore, compared with the traditional cloud platform 500, the resource granularity generated in the cloud platform 500 is lower. Moreover, in the system, obstacles affecting communication, caused by a high degree of data mixing or similar reasons, will not be produced, such as, system crashes and downtimes, thereby improving the stability of the system. Compared to the traditional cloud platform 500, the system can also be applied online.

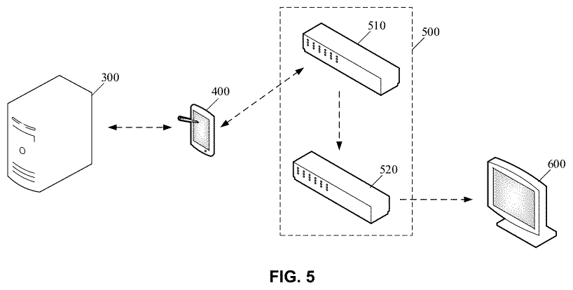

Referring to FIG. 5, FIG. 5 is a schematic system structural diagram of another online video data output system provided by an embodiment of the present application. The schematic structural diagram of the online video data output system shown in FIG. 5 is obtained by improving the schematic structural diagram of the online video data output system shown in FIG. 4. In various embodiments, the cloud platform 500 is composed of a first device 510 and a second device 520 in combination.

The first device 510 is configured to receive real-time information, and process data according to the real-time information to obtain image information.

The first device 510 is also configured to acquire rendering data from the image information, and transmit the rendering data to the second device 520.

The second device 520 is configured to receive the rendering data, and perform rendering according to the rendering data to obtain a rendered video.

The second device 520 is also configured to process the rendered video to obtain video data, and output the video data.

Optionally, any of the explanations and descriptions described in the foregoing can be applied to the online video data output system, which will not be repeated in this application.

By implementing this embodiment, it is possible to separate the data interaction and the running software from the rendering work, so that the first device 510 has a stronger ability to process data interaction (compared to the processing of full data content, because the hardware work content is more specific, the working ability can be improved), so that the rendering which the second device 520 makes on the rendering data is more professional (it can be understood that the rendering effect is better). Therefore, in a professional work system, the resource granularity generated by the cloud platform 500 must be relatively low. When applied to the system described in the above implementation process, it can also be compatible with online operations (referring to the interaction operation between the server 300, the client 400 and the cloud platform 500).

Optionally, the client 400 may be configured to receive real-time information, obtain interaction information based on the client 400, and transmit the interaction information and real-time information to the first device 510.

The operation of the first device 510 being configured to receive real-time information and process data based on the real-time information and obtain image information includes: receiving interaction information and real-time information, and processing data based on the interaction information and real-time information, to obtain image information.

By implementing this embodiment, in the process of acquiring the image information, the first device 510 may also perform the processing and the acquisition according to the interaction information transmitted by the client 400, to obtain image information related to the interaction information input by the user in real time. As a result, it is possible to strengthen online interaction capabilities and at the same time increase the ability to interact with users.

Optionally, the online video data output system further includes a server 300, the first device 510 is also configured to process data according to the interaction information to obtain operation information;

the first device 510 is also configured to transmit operation information to the client 400;

the client 400 is also configured to receive operation information and transmit the operation information to the server 300; and

the server 300 is configured to receive operation information and update real-time information according to the operation information.

By implementing this embodiment, the online video data output system further includes the server 300, that is, the online video data output system may include the server 300, the client 400, the first device 510, and the second device 520. Correspondingly, the online interaction process can perform the interaction between these four, and the content described in the above-mentioned implementation process is part of the content that the real-time information is replaced according to the operation information of the user in the real-time interaction. On the basis of it, the real-time information will also be updated according to the content, such as the clock or underlying data, in the server. Therefore, this part of the content is used to represent that in the online video data output system, it can also include the interaction process for the interaction information (or operation information), thereby improving the compatibility and versatility of the system, so as to enhance the interactive ability.

Optionally, the online video data output system further includes a display terminal 600, the display terminal 600 is configured to receive video data, and process the video data to obtain a display video; and the display terminal 600 is also configured to output display videos.

By implementing this embodiment, the online video data output system further includes a display terminal 600, which may be a display terminal of a rendered video (that is, a display video) corresponding to the video data. In the above-mentioned system, the display terminal can be mainly configured to display the rendered video, so as to ensure the integrity of the system and provide an output device for the rendered video.

Optionally, the client 400 is also configured to perform the processing according to real-time information to obtain real-time video, and output the real-time video.

By implementing this embodiment, the client 400 may also perform rendering and output real-time video according to the real-time information after receiving the real-time information. The client 400 may be a device having a display function and an image processing function. In the system, it can be ensured that the system can perform the display during use of the user and can also perform the output and display on the outside, thereby ensuring the comfort of interactive use of users, and can also meet the real-time requirements and effect requirements when other people are viewing.

Optionally, during the operation of the system, other software or other devices can be added to improve the effect of the output video data. For example, a barrage or icon can be added to the video data by built-in software of the second device 520.

Optionally, the system can be applied to live broadcast and document sharing, which is not limited in this application.

Optionally, the cloud platform included in the online video data output system may be the cloud platform described in the foregoing, which will not be repeated in this application.

Optionally, any of the explanations and descriptions described in the foregoing can be applied to the online video data output system, which will not be repeated in this application.

It can be seen that by implementing the online video data output system described in FIG. 5, it can complete the output of online video data through the interaction between the client and the cloud platform and the work of the cloud platform. The processing, which is made on real-time information by the cloud platform, involves image information and rendering data, that is, the work of the cloud platform has its target (that is, for images and rendering). Therefore, compared with the traditional cloud platform, the resource granularity generated in this cloud platform is lower, and the system will not produce obstacles affecting communication, such as system crashes and downtimes, caused by the high degree of data mixing or similar reasons, thereby improving the stability of the system. Compared to traditional cloud platforms, this system can also be applied online. It can also be compatible with various display peripherals and client carriers, so that the system can be organically compatible with various equipment or scenes related thereto, so that the system has corresponding universality.

An embodiment of the present application also provides a live broadcast device, including a memory and a processor. The memory is used to store a computer program, and the processor runs the computer program so that the live broadcast device executes the online video data output method according to any one of the above embodiments of the present application.

An embodiment of the present application provides a computer-readable storage medium that stores computer program instructions. When the computer program instructions are read and run by a processor, the online video data output method according to any one of the foregoing embodiments of the present application is executed.

The functional modules in the various embodiments of the present application may be integrated together to form an independent part, or each module may exist alone, or two or more modules may be integrated to form an independent part.

The functions, if implemented in the form of a software function module and sold or used as an independent product, can be stored in one computer readable storage medium. Based on such understanding, the technical solution of the present application can be embodied in the form of a software product. The computer software product is stored in a storage medium and includes several instructions to enable a computer device (which can be a personal computer, a server, or a network equipment, etc.) to execute all or part of the steps of the method described in each embodiment of the present application. The aforementioned storage media include: U disk, mobile hard disk, read-only memory (ROM), random access memory (RAM), magnetic disks or optical disks and other media that can store program codes.

The above are only specific embodiments of the present application, but the protection scope of the present application is not limited to this. Any person skilled in the art can easily think of changes or substitutions within the technical scope disclosed in the present application, which should be covered within the scope of protection of the present application. Therefore, the protection scope of the present application shall be based on the protection scope of the claims.

### INDUSTRIAL APPLICABILITY

Based on this technical solution, online interaction tasks can be completed in real time, and real-time video data can be transmitted, ensuring the progress of online tasks. Through the extraction and classification on real-time information, the acquisition of image information and even rendering data is completed, and further the generation of rendered videos is completed through the combination of resource scheduling and rendering data in the cloud platform, thus forming a generation process for rendered video in which a task is performed dedicatedly, thereby reducing the resource granularity in the cloud platform.

What is claimed is:

1. An online video data output method, wherein the online video data output method is applicable to a cloud platform, and the method comprises steps of:
receiving real-time information transmitted by a client, and processing data according to the real-time information to obtain image information, wherein the real-time information is transmitted from a server to the client so that the client forwards to the cloud platform;
acquiring rendering data from the image information, and performing rendering according to the rendering data to obtain a rendered video;
processing the rendered video to obtain video data, and outputting the video data.

2. The online video data output method according to claim 1, wherein the step of receiving real-time information transmitted by a client, and processing data according to the real-time information to obtain image information comprises steps of:
receiving interaction information and real-time information transmitted by the client;
processing data according to the interaction information and the real-time information to obtain image information.

3. The online video data output method according to claim 2, wherein after the step of receiving interaction information and real-time information transmitted by the client, the method further comprises steps of:
processing data according to the interaction information to obtain operation information, transmitting the operation information to the client, so that the client forwards the operation information to the server, and triggers an operation of the server for updating the real-time information based on the operation information.

4. The online video data output method according to claim 1, wherein the step of processing the rendered video to obtain video data, and outputting the video data comprises:
processing the rendered video to obtain video data, and outputting the video data to a display terminal corresponding to the cloud platform for being processed and displayed.

5. The online video data output method according to claim 1, wherein the cloud platform comprises a first device and a second device, the first device is an operating server, and the second device is a rendering server; or the first device is an operating platform, the second device is a rendering platform, and the operating platform is any one of multiple operating platforms included in the operating server, and the rendering platform is any one of multiple rendering platforms included in the rendering server.

6. The online video data output method according to claim 5, wherein the step of receiving real-time information transmitted by a client, and processing data according to the real-time information to obtain image information comprises a step of:
receiving real-time information transmitted by the client through the first device, and processing data according to the real-time information to obtain image information; and
the steps of acquiring rendering data from the image information, and performing rendering according to the rendering data to obtain a rendered video and processing the rendered video to obtain video data and outputting the video data comprise steps of:
acquiring rendering data from the image information by the first device, and transmitting the rendering data to the second device;
receiving, by the second device, the rendering data, performing rendering according to the rendering data to obtain a rendered video, processing the rendered video to obtain video data, and outputting the video data.

7. The online video data output method according to claim 6, wherein the step of receiving real-time information transmitted by the client through the first device, and processing data according to the real-time information to obtain image information comprises a step of:
acquiring interaction information of the client through the first device and receiving real-time information transmitted by the client, and processing according to the real-time information and the interaction information to obtain image information, with the image information comprising control information; and
the step of acquiring rendering data from the image information by the first device and transmitting the rendering data to the second device comprises a step of:
decoupling the control information in the image information by the first device to obtain rendering data, and transmitting the rendering data to the second device.

8. The online video data output method according to claim 7, wherein the step of decoupling the control information in the image information by the first device to obtain rendering data, and transmitting the rendering data to the second device comprises:
decoupling the control information in the image information by the first device to obtain business logic data and rendering data;
extracting the rendering data through the first device, and transmitting the rendering data to the second device, and
the method also comprises:
processing by the first device the business logic data to advance a business logic progress of the first device.

9. The online video data output method according to claim 7, wherein the control information is obtained by the first device performing a data processing on acquired interaction information of a first client; and
after the step of the second device processing the rendered video to obtain video data and outputting the video data, the method further comprises:
transmitting the video data to the first client through the second device, so that the first client displays a video corresponding to the video data; or, transmitting the video data to the first client and a second client through the second device, so that the first client and the second client display a video corresponding to the video data.

10. The online video data output method according to claim 7, wherein the interaction information comprises game operation information, and the control information is obtained by the first device performing a data processing on acquired game operation information of the client; and
the video data comprises game video data, and the step of receiving by the second device the rendering data, performing rendering according to the rendering data to obtain a rendered video, processing the rendered video to obtain video data, and outputting the video data comprises:
receiving by the second device the rendering data, performing rendering according to the rendering data to obtain a rendered video, processing the rendered video to obtain rendered game video data, and outputting the game video data.

11. The online video data output method according to claim 7, wherein the interaction information comprises working software information, and the control information is obtained by the first device performing a data processing on acquired working software information of the client; and
the video data comprises working video data, the step of receiving by the second device the rendering data, performing rendering according to the rendering data to obtain a rendered video, processing the rendered video to obtain video data, and outputting the video data comprises:
receiving by the second device the rendering data, performing rendering according to the rendering data to obtain a rendered video, processing the rendered video to obtain rendered working video data, and outputting the working video data.

12. The online video data output method according to claim 7, wherein the interaction information comprises remote meeting communication information, and the control information is obtained by the first device performing a data processing on acquired remote meeting communication information of the client; and
the video data comprises remote meeting video data, the step of receiving by the second device the rendering data, performing rendering according to the rendering data to obtain a rendered video, processing the rendered video to obtain video data, and outputting the video data comprises:
receiving through the second device the rendering data, performing rendering according to the rendering data to obtain a rendered video, processing the rendered video to obtain rendered remote meeting video data, and outputting the remote meeting video data.

13. The online video data output method according to claim 7, wherein when the cloud platform is used to run a game software, the step of acquiring interaction information of the client through the first device and receiving real-time information transmitted by the client, and processing according to the real-time information and the interaction information to obtain image information comprises:
performing a data segmentation processing by the first device according to received real-time information transmitted by the client to obtain scene information and game architecture data information corresponding to the game software;
adjusting, by the first device, the scene information according to acquired interaction information of the client and the game architecture data information to obtain image information.

14. The online video data output method according to claim 6, wherein the step of receiving by the second device the rendering data and performing rendering according to the rendering data to obtain a rendered video comprises:
receiving, by the second device, the rendering data, acquiring a network material corresponding to the rendering data, and rendering the rendering data and the network material to obtain a rendered video.

15-21. (canceled)

22. A live broadcast device, wherein the live broadcast device comprises a memory and a processor, the memory is configured to store a computer program, and the processor can run the computer program to make the computer device execute steps in the online video data output method according to claim 1.

23. A readable storage medium, wherein computer program instructions are stored in the readable storage medium, wherein when the computer program instructions are read and run by a processor, steps in the online video data output method according to claim 1 are executed.
